(19) United States
(12) Patent Application Publication
(10) Pub. No.: US 2003/0012325 A1
(43) Pub. Date: Jan. 16, 2003

(54) Mixture containing rare earth and the use thereof

(76) Inventors: Norbert Kernert, Bruchsal (DE); Klaus Schlosser, Eggenstein-Leopoldshafen (DE); Wolfgang Fleig, Halle (DE); Joachim Lesske, Halle (DE); Martin Luckner, Halle (DE); Matthias Brandsch, Halle (DE); Gerd Hause, Halle (DE); Reinhard Paschke, Langenborgen (DE); Manfred Arnold, Leissling (DE); Willy Frank, Grossgrafendorf (DE)

Correspondence Address: KLAUS J. BACH & ASSOCIATES, PATENTS AND TRADEMARKS, 4407 TWIN OAKS DRIVE, MURRYSVILLE, PA, 15668, US

(21) Appl. No.: 10/131,504

(22) Filed: Apr. 19, 2002

Related U.S. Application Data
(63) Continuation-in-part of application No. PCT/EP00/10884, filed on Nov. 4, 2000.

(30) Foreign Application Priority Data
Nov. 9, 1999 (DE) 199 53 636.8
Nov. 9, 1999 (DE) 199 53 637.6

(51) Int. Cl. G21G 1/00

(52) U.S. Cl. 376/202

(57) ABSTRACT

A thulium oxide-containing mixture consisting of a matrix material in which the thulium oxide is homogeneously distributed and forms therewith a body, which can be radioactivated by exposure to neutron radiation.

This is a Continuation-in-Part application of international application PCT/EP00/10884 filed Nov. 4, 2000 and claiming the priority of German applications 199 53 638.8 and 199 53 637.6 both filed Nov. 11, 1999.

### BACKGROUND OF THE INVENTION

The invention relates to a mixture containing rare earth and the use thereof.

Radioactive medical products, which are inserted in a body for example in the form of stents for the drainage of bile in connection with tumor-caused stenoses, are well known. In the conventional products of this type metals are used as radiation sources which, in the form of a wire spiral, are directly inserted into body cavities such as the bile duct (EP 539 165) or which are disposed in the interior of a stent/catheter (EP 539 961). In order to prevent mechanical damage, the radioactive sources are generally coated (EP 778 051). However, the mechanical resistance of the metallic radiation sources is relatively small when a particular diameter is exceeded so that for example coils of thin wire must be used. Furthermore, the radiation sources disposed in the interior reduce the open cross-section of stents or catheters so that they clog relatively easily. The devices described above are furthermore relatively complicated and expensive and therefore find little use in practice.

EP 778 051 discloses the manufacture of wire consisting of thulium which wire, after radio-activation, is suitable as a radiation source. However, metallic thulium is an unstable compound, which is decomposed by water and body liquids. The metallic thulium must therefore be enclosed by a coating of for example titanium, which protects the core from mechanical and chemical influences. For the manufacture of thulium-containing coated wire, an expensive procedure is required. It comprises the manufacture of a core and a coating, the extrusion of a relatively thick wire to form a wire of the desired diameter, the cutting of the wire to the desired lengths and the careful sealing of the ends, which must be completely enclosed in the coating.

It is furthermore known to coat the stents with an antigen and to attach a radio-marked antibody to the antigen (WO98/43694). Their manufacture however is complicated and expensive so that they have not found routine clinical applications.

WO 92/03170 suggests the use of micro-spheres, which consist of radioactive material surrounded by several layers and to use them directly or contained in a tape or wire. In this case, however, the process of manufacturing such micro-spheres is also quite expensive.

It is the object of the present invention to provide materials, which can be neutron-activated so as to become radioactive and which are usable for, and adaptable to, various applications and which are furthermore easy to manufacture and easily neutron activated.

### SUMMARY OF THE INVENTION

In accordance with the present invention such a compound is a thulium oxide containing mixture consisting of a matrix material in which the thulium oxide is homogeneously distributed and forms therewith a body, which can be radio-activated by exposure to neutron radiation.

As a result of the radioactivity of the material treated with neutrons, the growth of tumor cells is limited, or respectively, the formation of scar stenoses is prevented. The use of radioactivity on the basis of a suitable matrix material makes it possible to dose the radioactivity in place and to avoid collateral damage upon use thereof in medical applications.

The use of an inert compound of the rare earths, especially inert thulium oxide ensures that no undesirable reaction occurs upon contact with body liquids or tissues whereby the material may be changed or the body is subjected to chemical damage. Thulium oxide is water insoluble and body compatible. Particles of different sizes of this material can easily be manufactured and can be mixed with different matrix materials (among them polyethylene, polyamide, polypropylene, polytetafluoroethylene, polyvinylidenfluoride, silicone and PMMA (highly densified plexiglass). It is the purpose of the matrix material to contain the thulium oxide homogeneously and enclose it permanently while providing for a suitable shape.

It is advantageous that thulium occurs in nature only in the form of one stable isotope so that, during radio-activation, no other radioactive isotopes are formed. Furthermore, the decay product ¹⁷⁰Yb is also a stable isotope so that no further nuclear decays occur. Also, the ¹⁷⁰Tm decays mainly by β radiation which has a suitable range for many applications of therapy. In a small part (only about 2.5% of all decays) a 80 KeV γ radiation is emitted. The corresponding radiation dose deposited in healthy tissue outside the tumor or the target, is negligible.

It is further an advantage that the components and products made from these materials can again be radio-activated when their radioactivity has faded (for example, because of an excessive storage time). The part materials can also be recycled and other or the same products can be manufactured therefrom after grinding and renewed extrusion and radio-activation.

With the radio-activation by neutron irradiation the nucleus of the thulium-169 is converted to an unstable state in the form of thulium-170, which decays with a half life of about 4 months (128.6 days) while releasing β and γ radiation. Because of its large cross-section for thermal neutron capture thulium is particularly suitable for the manufacture of radio-active implants. The first β radiation (rel. intensity about 81.6%) has a maximum end point energy (maximum energy) of 986 keV (average energy 323.1 keV), the second fraction (rel. intensity of about 18.3%) has a maximum energy of 883 keV (average energy 290.5 keV). The emitted β radiation has a range in tissue of only a few millimeters.

The content of thulium in the matrix material is 0.1 to 25%. With an addition of more than 25% of rare earth components, the material costs would increase and the mechanical properties of the matrix materials would change, for example, the brittleness would increase. With a low content of less than 0.1%, the irradiation times in the neutron flux would be excessively high. With excessively long irradiation times however, the irradiation procedure becomes too expensive and radiation damage to the matrix material may occur.

For these reasons, a thulium content of 4 to 25 wt % on the basis of the matrix material is considered to be advantageous.

As matrix materials, very different materials are suitable such as plastics like polyethylene, polyamide, polypropylene, polytetrafluoroethylene, polyvinylidenfluoride, PMMA, or silicone, also with reinforcements by fiber materials, glass, polymers, ceramics, metals and their alloys, teflon, glass fibers, carbon fibers, dental and bone cement, silicone compounds as well as organic and bio-organic compounds. It is only necessary that the matrix material can be mixed with the inert compound of the rare earths (as a stable or unstable isotope), maintains the required mechanical properties and has the needed chemical stability particularly with respect to body fluids. With the multitude of possible matrix materials, it is possible in most cases to choose materials which have already been used for the particular application, particularly in the medical field, that is, materials whose properties are known, and to mix these materials with a suitable amount of the inert compound of rare earths and radio-activate them subsequently. It is for example possible to make heart valves flaps of thulium oxide mixed with carbon fiber containing plastic materials or to produce stents and catheters of thulium oxide and polyethylene.

For the use as endoprostheses in the area of the bile ducts and the pancreas passages polyethylene has been found particularly advantageous because of its flexibility, durability, and resistance to body fluids, low cost and simple processing.

If the rare earth content is lower than 15 wt %, additional x-ray contrast material such as bariumsulfate can be added to increase the visibility under fluoroscopy. Compounds containing Mercury or bismuth should be avoided. Irrsdiation of mercury with thermal neutrons would yield significant but unwanted amounts of Hg-203. Although bismuth has only a small cross-section for thermal neutron capture, α-ray emitting isotopes are produced, which could result in problematic α contamination. With the use of Teflon (fluorized matrix) no additional contrast material is needed for achieving visibility with MRT. For good contrast in the x-ray fluoroscopy a contrast material content of for example more than 10 wt % based on the matrix material is advantageous. A content over 40% results in an excessive change of the mechanical properties for example with regard to brittleness and flexibility, so that the contrast material content of the end product should be between 10 and 40%.

The material that is to be radio-activated comprises a matrix and thulium oxide (and additional contrast material if desired). To form end products the materials can be combined before or after the radio-activation with additional radio-activatable or radioactive or non-radioactive materials or components.

Depending on the desired results different substances with different half lives, radiation types and energies may be combined. For example, a combination with additional rare earths with smaller half-lives would make sense for generating a high initial dose. It is furthermore possible to introduce radioactivity into the material for example by additional implantation of ³²P into the surface.

Depending on the circumstances, it may be advantageous to make only that part of a catheter radioactive which comes into direct contact with the scarred stenosis to be treated.

For strengthening the stents or for achieving certain mechanical properties the material can be deposited on an inert carrier for example of a plastic material or metal or respectively, metal grid.

It is advantageous to activate the stents by neutrons after their treatment by a medically approved sterilization and sterile packaging since, in this way, additional handling and processing steps involving radioactive materials can be avoided. The γ radiation dose involved with a neutron irradiation in a reactor also has sterilizing effects.

The level of the radioactivity emitted later cannot only be controlled and determined in advance by the content of thulium oxide but also by adjusting the duration and intensity of the neutron irradiation. This is made clear with the following formula for the calculation of the resulting radioactivity per cm probe length: A=n^{σφ} ln 2 T/_{½} (n=number of Tm-atoms/cm; σ=105 barn=105×10⁻²⁴ cm²; T_{½}=half life=128.6 d; φ=1.85×10¹² neutrons/cm²s; t=irradiation time).

The radioactive material or, respectively, the radioactive endoprosthesis are well body-compatible and serve as therapeutic materials in humans and in animals, The β- and γ-radiation emitted from the end product by the, radio-activation may in principle inhibit cell growth that is the growth of tumor cells, fibroblasts and bacteria.

It is the aim, first to inhibit the cell growth of eucharyotic cells and if possible to destroy also dormant eucharyotic cells. In order to destroy also prokaryotic cells such as bacteria and fungi or to prevent further growth thereof substantially higher doses are required as in the case of eukaryotic cells. This is important for particular applications in the human body, for example, to prevent a growth of prokaryotic organisms on the implant surface, also in combination with other processes, for example, silver coating or an antibiotic therapy. With the rapid decline of the effective dose with increasing distance from the stent prokaryotic cells particularly on the implant surface are affected.

Stents in the form of hoses are used as endoprostheses for keeping tubular passages, such as bile ducts or air ducts, passable.

The invention will be described in detail on the basis of examples.

### DESCRIPTION OF EXAMPLES

### Example 1

Manufacture of the Materials

To Polyethylene, whose constitution is approved for the manufacture of bile duct- and pancreas-passage-prostheses 5% thulium oxide (Tm₂O₃) in powder form (as it is commercially available or finely ground in a ball mill) as well as 20% BaSO₄ serving as additional contrast material are added. They are intensely mixed. Upon melting (heating to 200° C.) the finely ground particles remain suspended in the mixture and, after cooling of the polymer, are homogeneously distributed in the mass and firmly surrounded by the plastic material.

### Example 2

Manufacture of Bile Duct Stents

From the molten plastic material according to example 1, using an injection molding machine or extruder, a hose with an inner diameter of 2.5 mm and a wall thickness of 0.25 to 0.5 mm is produced. This hose is then further processed to endoprotheses with the common dimensions by cutting the hose into sections of 5 to 10 cm length. To both ends of these sections, parts of a plastic hose with the same diameters are welded which were manufactured without the addition of thulium oxide. With a stent of a total length of 14 cm, the end thereof adjacent the duodenum is free of thulium oxide over a length of 4 cm, in order to prevent damages at the intestinal mucus layer and other tissues. The end of the hose adjacent the liver is also kept free of thulium oxide over a length of 2 cm. At both ends of the unfinished stent a splint is raised which acts as a barb to facilitate anchoring of the stent in the bile duct.

The stents are placed into plastic bags, which are welded closed and sterilized with ethylene oxide. Then they are radio-activated by neutron irradiation in a nuclear reactor. In the following inspection the spectrum and the intensity of the emitted radiation are measured.

In order to obtain an activity of for example 18 μCi per cm hose length with a content of 4.38 wt % of ¹⁶⁹Tm, the irradiation time is about 135 min at a neutron flux of 2×10¹² n/cm²/sec. In order to inhibit proliferation in tumor cells an activity of 15 ^{μ}Ci/cm² is sufficient.

### Example 3

In order to inhibit in vitro cell growth for example of tumor cells or fibroblasts at a distance of 2 to 3 mm from a radioactive thulium oxide-containing plastic tube with a diameter of about 3 mm, about 6 to 20 ^{μ}Ci/cm tube length are required depending on the radiation sensitivity of the type of cells. In order to destroy dormant endokaryotic cells in the same test set-up, higher radiation doses are necessary. Those are, depending on the radiation sensitivity of the cell, about 12 to 50 ^{μ}Ci/cm.

The neutron-activated material consisting of a matrix and the inert compound of rare earths can be combined before or after the activation with additional radioactivatable, radioactive or non-radioactive materials or compounds.

Depending on the desired effect different radioactive or radioactivatable substances with different half-lives, radiation types and energy may be utilized for that purpose. For example, a combination with additional inert compounds of the rare earths with small half-lives would be reasonable in order to provide a high initial dose. Furthermore, additional radio-activity may be inserted into the material for example by ion implantation of ³²p into the surface.

The neutron activated radioactive materials can be used as therapeutic means in humans and animals.

They are suitable as medical products such as implants for example for surgical procedures, endoprostheses, catheters, stents, for the targeted embolization of malignant space requirements, for external applications on the skin, as components of artificial heart valves, or as plugs in the field of eye therapeutics.

Stents or catheters of radioactive materials are suitable in the arterial, the venous, the peritoneal, the periduval and the cerebral (ventricle drainage) fields.

Depending on a particular problem, it may be advantageous to make only a part of a hose section of plastic material including thulium as radioactivable component and to weld this section together with a thulium-free hose.

In order to save material and to reduce the γ-radiation part, the material can be deposited on an inert support member for example on plastics, metals or metal grids.

It is advantageous that the medical products can be packaged in a medically approved and a sterile manner before the activation by neutrons occurs. In this way, handling and production activities involving radioactive materials are avoided.

The level of the radioactivity emitted later can be controlled not only by the content of the inert compounds of the rare earths and calculated in advance but this is also possible by adjusting the duration and intensity of the neutron irradiation. In the range relevant for technical and medical applications, the obtained radioactivity is increased proportionally with the irradiation time. This is apparent for the example of thulium oxide also from the following approximation formula for the calculation of the resulting radioactivity per cm probe length; A=n^{σφ} ln 2 t/T_{½}, wherein n=number of Tm atoms/cm, σ=105 barn=105×10⁻²⁴ cm², T^{½}=halflife=128.6d, φ=1.85×10¹² N/cm²s, t=radiation time.

For medical and technical applications several activity ranges are of interest for which the radioactivity can be adjusted. It is desirable to dose the radioactivity in such a way that the growth of eucharyotic cells is prevented.

In order to prevent the cell growth in vitro for example of tumor cells or fibroblasts at a distance of 1 mm from a radioactive thulium oxide-containing plastic tube with a diameter of about 3 mm about 6-35 _{μ}Ci/cm hose length—depending on the type of cell are needed. In order to destroy dormant eucharyotic cells in the same test setup, higher radiation doses are necessary. They are about 12-80 _{μ}Ci/cm² material surface depending on the radiation sensitivity of the cell.

It may further be desirable to destroy also prokaryotic cells such as bacteria and fungi or at least to prevent further growth thereof. This is important for certain applications in the human body for example to prevent growth on the implant surface of prokaryotic organisms and the results thereof such as septic strokes, the formation of abscesses and the formation of centers for further infections particularly because implant infections have been difficult to treat. To this end, a neutron irradiation up to a radioactivity of 500 ^{μ}Ci/cm² material surface is advantageous. Also, the combination of these materials with another method such as silver coating or an antibiotic therapy is possible.

It is noted that, with the steep drop of the applied dose, the prokaryotic cells particularly on the implant surface are highly affected while the effect on eucharyotic cells which are not directly adjacent the implant is much lower.

These materials are also important for the prevention of germ growth on parts of medical installations or apparatus. For this purpose, a neutron radiation up to a radioactivity of 20,000 ^{μ}C/cm² material surface is reasonable.

This effect is useful particularly in connection with components which cannot easily be exchanged but still have to fulfill aseptic criteria for example because they come into contact with organic materials for example filter installations, hose systems, collection containers etc.

### Further Examples

### Example 4

In the form of small balls of plastic material, the materials are suitable for the targeted embolization, by way of an arterial access, in a tumor or a metastasis, in order to be held in the capillary area and to achieve in this way a localized growth inhibition. The advantage of the concept is that, in comparison with an embolization with non-radioactive substances, (for example starch particles) will, beyond the mechanical and nutritive effects of a disturbed blood supply, also affect cells which are disposed in the circumferential area of the tumor and are supplied by other vessels. Because of the relatively long half life of thulium oxide of about 4 months, also dormant tumor cells which are substantially less radiation sensitive than proliferant cells, can be reached. As a result, the recidivism quota is lowered in comparison with a pointed external irradiation or an embolization with substances having shorter half lives. A long-term elimination of a local recidivism is possible.

The use of a targeted radio embolization however is not limited to arterial flow areas—in contrast to conventional embolizations, but is also possible in lymph passages. In this way, lymphogenic metastases of a malignant melanoma at an extremity can be treated by the injection of radioactive thulium-oxide-containing polyethylene spheres. It is advantageous in this connection that the radioactivity is spread along the metastasizing passages and can therefore be accurately targeted. As a result, the radiation dose beyond the target volume is substantially smaller than with external radiation.

For the manufacture of these particles 5% finely ground thulium oxide is added to body compatible polymer ethylene.

The thulium oxide makes the later radioactivation possible. Upon melting (heating up to about 200° C.), the finely ground particles remain suspended in the mixture and after the polymer has cooled down they are homogeneously distributed in the material and firmly encased by the plastic material. From this material small polyethylene particles with a diameter of for example 30-100 μm are prepared. The material may also be cooled and then ground. The desired particle size is obtained by filtration or screaming procedures. Subsequently, the particles are activated by neutron bombardment in a nuclear reactor.

### Example 5

Plastic materials whose composition is approved for the manufacture of urinary tract catheters are mixed with 5-25% Thulium oxide, which has been finely ground in a ball mill. Upon melting of the mixture (heating to 200° C.), the finely ground particles remain suspended in the mixture and, after cooling of the polymer, are homogeneously distributed in the material and firmly encased in the plastic.

From the molten plastic, a hose with for example an inner diameter of 2.5 μm and a wall thickness of 0.25 mm is manufactured by an injection molding machine (extruder). This hose is then further processed into a double J-catheter with conventional dimensions by cutting it into sections of 5-10 cm length. At both ends of these sections, pieces of a plastic hose of the same diameter are attached. These plastic hose pieces are free of thulium oxide. Both ends are bent into a J-shape (for example, by bending when heated) in order to hold the catheter later in the proper position. The part of the catheter, which comes directly into contact with scarred stenosis or tumor stenosis that is to be treated, is then radioactivated. By the radioactivity, a recidivity of the scarred stenosis (inhibition of fibroplast growth) is prevented or, respectively, the growth of tumor cells is limited. The stents are melted into plastic bags and sterilized with ethylene oxide.

It is an advantage that at the same time germ growth on the surface of the catheter is reduced.

### Example 6

Materials such as fiber reinforced plastics (carbon fibers), which are approved for making heart valve flaps, are mixed with 0.5-3% by weight thulium oxide finely ground in a ball mill. Upon melting, the finely ground thulium particles remain suspended in the mixture homogeneously distributed and, after addition of fibers, can be brought into a desired form. The thulium oxide is homgenously distributed in the polymer after it is cooled down and is firmly enclosed in the matrix. The body is then radioactivated by neutron bombardment in a nuclear reactor.

With radioactive heart valve flaps made from such material the growth of bacteria thereon, which may cause the formation of a septic thrombus, is prevented. Because of the intense movement of the heart valve flap, thrombi localized at the heart valve tend to be carried as emboli to other areas, for example into the brain where they cause infarctions. With the β-radiation of the radioactive material a high surface dose is obtained which prevents the growth of germs. In addition, a mechanical heart valve flap has no direct contact with the heart muscle tissue so that, because of the short range of the radiation of for example ¹⁷⁰Tm, damage to the heart muscle cells is negligible. Such a heart valve flap can be combined with non-radioactive material to form a heart valve.

### Example 7

Surgical implantations such as screws, plates, joints and joint parts which consist either of plastic material with or without fiber reinforcements or of metal alloys or of combinations of the two materials are mixed with finely ground thulium oxide for example in an amount of 0.5-10 wt %. Combinations of the two materials are possible for example in the form of a metal core surrounded by a thulium oxide containing plastic coating. As plastic materials particularly duro-elastic materials and materials with a high impact strength and fracture resistance are suitable.

Examples are polyethylene-HD compounds and polyaramide compounds. Upon melting, the finely ground compounds remain suspended in the mixture homogeneously distributed and are injected by an injection molding technique for example around a metal body which forms the center thereof. The body is then radioactivated by neutron bombardment in a nuclear reactor.

### Example 8

Various applications of radioactive materials are possible in connection with the human eyes since, because of the closely adjacent highly differentiated areas, tumor surgery such as retino- and melanoblastoma often results in a loss of the organ functions or at least in a reduction of the vision. On the other hand, it is often impossible to treat inflammable or proliferative areal infections at the retina and the choroid membrane (for example, periphiebitus retinae, passarteriites nodosa, thrombangitis obliterans, diabetic retinoapathy) with the conventional medication therapies and invasive retina treatments such as kryo- or laser coagulation which result only in spot scars.

For both indications radioactive thuliumoxide-containing (for example, with a thulium content of 0.1-25%) plugs of plastic material (for example, polyethylene, transparent silicone polymers or thermoelastic plastics) may be stitched to the outside of the eye or attached inside the eye adjacent the retina in order to stop proliferative processes, which may lead to further retina damage. But also retina tumors such as retinoblastomers, which cannot be eliminated by a sight-maintaining surgery because of their size, can be treated with such plugs before or after surgery or without surgery. By radioactivity particularly also individual infiltrating tumor cells can be reached which otherwise cannot be treated. Thulium oxide appears to be particularly suitable for this kind of application because of the range of its β-radiation of only a few millimeters, its half-life which makes extended application possible in order to destroy also dormant cells and the relatively small amount of γ radiation which may cause clouding of the lens and is superior to conventional types of irradiation. Upon melting, the finely ground thulium oxide compound remains homogeneously distributed in suspension in the plastic mixture. The mixture can be brought into the desired shape for example by injection molding and the material body can subsequently be radioactivated by electron bombardment in a nuclear reactor.

### Example 9

The radioactive materials are suitable for use in connection with tumors, which cannot be removed surgically because of their location, their large size, because of infiltrations or because of the general condition of a patient. This concerns tumors of the skin such as basalioms, melanomas or spinalioms and also of soft tissues. For the treatment of these tumors and particularly of small, macroscopically invisible colonies in the fringe areas around the tumor, a radioactive thulium oxide containing body for example in the form of a platelet of thermo-elastic plastic or polyethylene as matrix material with a thulium content of 0.1-25% can be attached or stitched on before or after an operation or also instead of an operation. For uneven anatomic locations easily deformable gel-like or liquid plastic polymers such as silicon polymers with the same thulium content may be used. Upon melting, the finely ground thulium oxide compound remains in the plastic mixture suspended and homogeneously distributed. It can be brought into a particular form by injection molding techniques. Subsequently, the body is radioactivated by neutron bombardment in a nuclear reactor. The advantage of this procedure is again the low radiation exposure of the surrounding tissue, the access to individual cells resident in the surrounding tissue, the possibility of ambulant treatment and the elimination of mutilating surgical procedures.

### Example 10

Components of technical apparatus for example in the medical field which are contaminated regularly or potentially by prokaryotic organisms and cells but which should be kept free of germs and which cannot be decontaminated easily and regularly such as collecting containers hose systems, filtering plants, housings of electronic components etc. may consist of the multitude of the materials mentioned above, for example of plastic materials including inert components with an addition of rare earth such as thulium oxide. Also, bodies of organic or bio-organic compounds such as cellulose, organic gels, starch etc can be protected from the growth and destruction by procharyants if the finely ground inert thulium oxide is suspended in the matrix in a homogeneously distributed manner and the bodies are then shaped as desired. The bodies are subsequently radioactivated by neutron bombardment in a nuclear reactor. Technical components can be subjected to substantially higher radioactivity than human bodies since the radiation generated by the Tu decay is easy to shield.

What is claimed is:

1. A thulium containing mixture consisting of a matrix material and thulium oxide homogeneously distributed in said matrix material, said mixture being radioactivatable by exposure to neutron radiation.

2. A thulium containing mixture according to claim 1, wherein the thulium content in said matrix material is 0.1 to 25 wt % of the matrix material.

3. A thulium containing mixture according to claim 1, wherein the thulium content in said matrix material is 3 to 6 wt %.

4. A thulium containing mixture according to claim 1, wherein said matrix material consists of bio-compatible plastics usable for medical applications.

5. A thulium containing mixture according to claim 1, wherein said matrix material consist of at least one of the group consisting of polyethylene, polyamide, polypropylene, polytetrafluorethylene, polyvinyliden fluoride, teflon, silicone and PMMA including optionally reinforcement fibers.

6. A thulium containing mixture according to claim 1, wherein an x-ray contrasting agent is added to said mixture.

7. A thulium containing mixture according to claim 1, wherein at least one additional radioactive or radioactivatable compound which has a half-life and radiation type and energy different from that of thulium is added to said mixture.

8. The use of a thulium containing mixture consisting of a matrix material and thulium oxide homogeneously distributed in said matrix material, said mixture being radioactivatable by exposure to neutron radiation as a therapeutic medium in humans and animals.

9. Stents for use as a endoprostheses for placement in the form of hoses in human and animal body cavities and passages, said stents comprising thulium containing a mixture consisting of a matrix material and thulium oxide homogeneously distributed in said matrix material, said mixture being radioactivatable by exposure to neutron radiation.

10. Stents according to claim 9, disposed in a packaging and radioactivated after closing of said packaging.

11. A radioactive material including at least one inert compound of the rare earths, which is distributed in a matrix material and has been radioactivated by neutron irradiation.

12. A radioactive material according to claim 11, wherein said inert compound of the rare earth is thulium oxide.

13. A radioactive material according to claim 11, wherein the content of compounds of the rare earth is between 0.1 and 25%.

14. A radioactive material according to claim 11, wherein said matrix material consist of at least one of the group consisting of polyethylene, polyamide, polypropylene, polytetrafluorethylene, polyvinyliden fluoride, teflon, silicon and PMMA including optionally reinforcement fibers.

15. A radioactive material according to claim 11, wherein an x-ray contrasting agent is added to said mixture.

16. A radioactive material according to claim 11, wherein at least one additional radioactive or radioactivatable compound which has a half-life and radiation type and energy different from that of thulium is added to said mixture.

17. A radioactive material according to claim 11, wherein said neutron irradiation is dosed.

18. A radioactive material according to claim 17, wherein said neutron irradiation is selected for providing a radioactivity of 80 μCi/Cm² material surface for destroying eucharyotic cells and preventing their growth.

19. A radioactive material according to claim 17, wherein said neutron irradiation is selected for providing a radioactivity of 20000 μCi/cm² material surface for destroying prokaryotic cells and for preventing their growth.

20. The use of a material mixture including a matrix material with thulium oxide homogeneously mixed with said matrix material and being radioactivatable by exposure to neutron radiation, in medical products consisting of the group of implants, endoprotheses, catheters, stents, heart valve components, plugs for eye therapy, and equipment components.
